(19) United States
(12) Patent Application Publication
(10) Pub. No.: US 2002/0067522 A1
(43) Pub. Date: Jun. 6, 2002

(54) OPTICAL TRANSMISSION LINE MONITORING APPARATUS AND RECEIVING STATION

(76) Inventors: HIDEAKI TANAKA, TOKYO (JP); KOJI GOTO, TOKYO (JP)

Correspondence Address: CHRISTIE PARKER & HALE, PO BOX 7068, PASADENA, CA, 911097068

(21) Appl. No.: 09/094,322

(22) Filed: Jun. 9, 1998

(30) Foreign Application Priority Data
Jun. 11, 1997 (JP) HEI 9 - 153622

(51) Int. Cl. H04B 10/08; H04J 14/02

(52) U.S. Cl. 359/110; 359/124

(57) ABSTRACT

An optical transmission line monitoring apparatus, comprising: monitor wavelength extracting means for extracting a predetermined monitor wavelength from input light; and judging means for judging whether any trouble is present in the optical transmission system by comparing the intensity of output light from said monitor wavelength extracting means with a predetermined threshold value.

### FIELD OF THE INVENTION

This invention relates to an optical transmission line monitoring apparatus and a receiving station.

### BACKGROUND OF THE INVENTION

In long-distance optical fiber transmission systems, an optical transmission line monitoring apparatus for monitoring breakage, or other like troubles, in the optical transmission line is arranged in a receiving station. A portion of a receiving station connected to the optical transmission line of a long-distance optical fiber transmission system includes two units, namely, an optical unit and an electronic unit, for facilitating their management and maintenance, and, heretofore, the electronic unit has been used for monitoring the optical transmission line.

FIG. 4 is a schematic block diagram showing a general construction of a conventional receiving station. Signal light output from a sending station 10 propagates through the optical transmission line 12 and enters into a receiving station 14. In case of a long-distance optical fiber transmission system, the optical transmission line 12 is made by repeating and connecting transmission optical fibers 12a made of dispersion shifted optical fibers via optical amplifiers 12b and by inserting dispersion compensation optical fibers 12c in appropriate intervals to compensate accumulated wavelength dispersion.

As referred to above, each receiving station 14 is equipped with an optical unit 20 and an electronic unit 30. The optical unit 20 includes an optical amplifier 22 directly connected to the optical transmission line 12, wavelength dispersion compensation fiber 24 for compensating accumulated wavelength dispersion of output light from the optical amplifier 22, and optical amplifier 26 for optically amplifying output light from the wavelength dispersion compensation fiber 24 to compensate its loss. The electronic unit 30 includes a photodetector 32 for converting output light from the optical amplifier 26 of the optical unit 20 into an electric signal, and a data demodulating circuit 34 for demodulating transmitted data from the output signal of the photodetector 32 and for reproducing the clock. The data demodulating circuit 34 generates an alarm when the clock cannot be reproduced. The alarm results in informing the administrators of a trouble or an abnormality of the transmission line 12. That is, the data demodulating circuit 34 also functions as the transmission line monitoring apparatus.

In this manner, conventional systems can monitor conditions of their optical transmission lines 12. However, when the data demodulating circuit 34 generates an alarm because of the clock not being reproduced, the alarm merely shows that a trouble has occurred at a portion before the data demodulating circuit 34. The data demodulating circuit 34 generates an alarm not only upon a trouble in the transmission line 12 but also upon a trouble in the optical unit 20, defect of the photodetector 32, deviation in optical axis of signal light to the photodetector 32 or malfunction inside the data demodulating circuit 34.

Therefore, when the data demodulating circuit 30 generates an alarm in a conventional system, various portions must be examined one by one retrospectively toward the sending station 10, and a long time and a high expense are required to find out the trouble point.

### SUMMARY OF THE INVENTION

It is therefore an object of the invention to provide an optical transmission line monitoring apparatus and a receiving station free from these problems and capable of detecting troubles in optical portions, namely, optical transmission line and optical unit, distinctively from troubles in electronic portions.

Another object of the invention is to provide an optical transmission line monitoring apparatus and a receiving station capable of detecting troubles in the optical systems easily and quickly.

According to the invention, monitor wavelength extracting means extracts a predetermined monitor wavelength from input light, and judging means compares the intensity of the output light from the monitor wavelength extracting means with a predetermined threshold value to judge whether any trouble is present in the optical transmission systems. Consequently, any trouble in optical transmission systems can be detected earlier, and the trouble in optical transmission systems can be identified and fixed quickly.

The monitor wavelength extracting means includes an optical grating element for selectively reflecting the monitor wavelength, and an optical circulator having three terminals A, B and C to transfer the input light to the optical grating element and to output the reflected light from the optical grating element through a terminal different from the input terminal of the input light. The monitor wavelength extracting means may be an optical filter. In this manner, the monitor wavelength can be extracted efficiently, using a simple structure. The output light from the optical circulator can be used for other purposes, such as reception processing.

The monitor wavelength extracting means may be wavelength demultiplexing means for demultiplexing the input light into a plurality of wavelength components including the monitor wavelength component. In this case, the invention can be readily applied to a wavelength-division multiplexing system and it is achieved inexpensively to monitor the transmission line in the wavelength-division multiplexing transmission system.

The judging means may include an opto-electric conversion means for converting the output light intensity of the monitor wavelength extracting means into an electric signal, and a comparator means for comparing the output of the opto-electric conversion means with the threshold value. Also an amplifier means may be provided, where appropriate, to amplify the output of the opto-electric conversion means. Thus, the monitoring apparatus can monitor very easily whether any trouble is present or not in the optical transmission system, and can inform administrators of troubles.

When a shorter wavelength than the signal light is used as the monitor wavelength, it is easier to set the threshold value for judgement the presence or absence of troubles.

### BRIEF DESCRIPTION OF THE DRAWINGS

FIG. 1 is a schematic block diagram showing a general construction of an optical transmission system to which an embodiment of the invention is applied;

FIG. 2 is a spectrally comparative schematic diagram of normal and troubled states of an optical transmission line;

FIG. 3 is a schematic block diagram showing a general construction of a second embodiment of the invention;

FIG. 4 is a block diagram schematically showing a conventional receiving station; and

FIG. 5 is a schematic block diagram of a general construction of a modified version of the embodiment shown in FIG. 1.

### DESCRIPTION OF THE PREFERRED EMBODIMENTS

Some embodiments of the invention are explained below in detail with reference to the drawings.

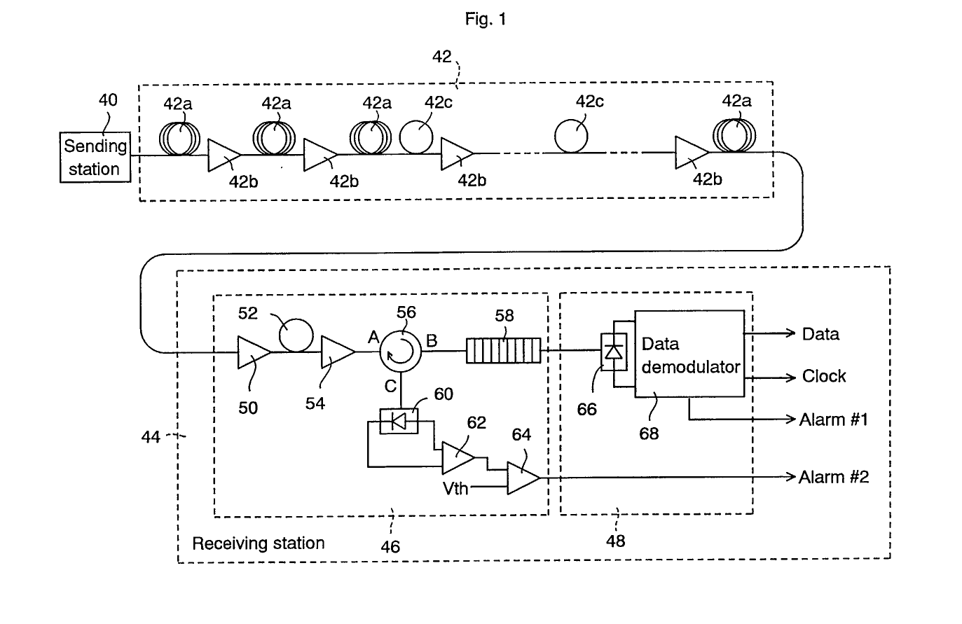

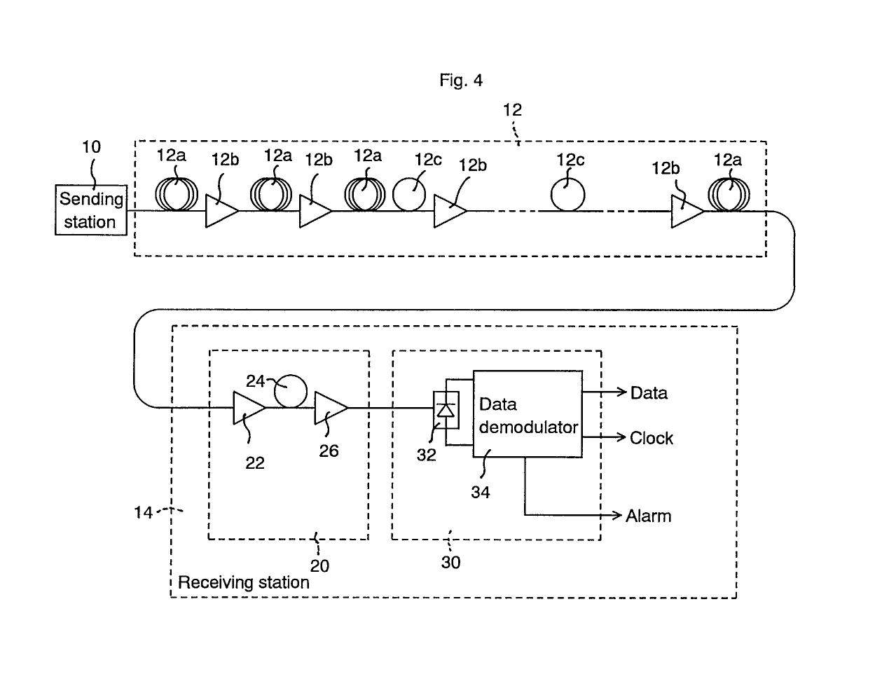

FIG. 1 is a schematic block diagram showing a general construction of an optical transmission system employing an embodiment of the invention. Its sending station 40 and optical transmission line 42 have the same constructions as those of the sending station 10 and the optical transmission line 12 shown in FIG. 4. Like the optical transmission line 12, the optical transmission line 42 is made by repeating and connecting transmission optical fibers 42a made of dispersion shifted optical fibers via optical amplifiers 42b and by inserting dispersion compensation optical fibers 42c at appropriate intervals to compensate accumulated wavelength dispersion.

Also in this embodiment, each receiving station 44 has two units, namely, optical unit 46 and electronic unit 48. The optical unit 46 includes, like the conventional structure, an optical amplifier 50 directly connected to the optical transmission line 42, wavelength dispersion compensation fiber 52 for compensating accumulated wavelength dispersion of output light from the optical amplifier 50, and optical amplifier 54 for optically amplifying output light of the wavelength dispersion compensation fiber 52 to compensate its loss.

The optical unit 46 used in this embodiment further includes means for extracting a spontaneously emitted light component or noise light of a wavelength λsp (hereinafter called the monitor wavelength) different from signal light, namely, an optical circulator 56 including three terminals A, B, C to output input light of the terminal A from the terminal B and to output input light of the terminal B from the terminal C, and an optical fiber grating 58 for selectively reflecting the wavelength λsp. That is, the terminal A of the optical circulator 56 is connected to the output of the optical amplifier 54, and the terminal B of the optical circulator 56 is connected to one end of the optical fiber grating 58. The terminal C of the optical circulator 56 functions as an extraction terminal for outputting the component of the monitor wavelength λsp to deliver its output light to a photodetector 60. The photodetector 60 may be one for detecting d.c. components in the spontaneously emitted light exclusively, and therefore may be a low-speed photodetector.

The monitor wavelength λsp preferably is a shorter wavelength than the signal light, for example. Although a longer wavelength than the signal light is acceptable as the monitor wavelength λsp, since erbium-doped optical fiber amplifiers, typically used as optical amplifiers, usually exhibit amplification gain wavelength characteristics in which gains are larger in the band of shorter wavelengths than signal light.

Output of the photodetector 60 is applied to an amplifier 62, and output of the amplifier 62 is applied to one input of the comparator circuit 64. The photodetector 60 and the amplifier 62 may be low-speed circuit elements in which output of the amplifier 62 exhibits the d.c. level of the monitor wavelength λsp entering into the photodetector 60. Applied to the other input of the comparator circuit 64 is a threshold value Vth for the alarm output. The threshold value Vth is set to a level higher than the intensity of the monitor wavelength λsp component in the normal condition of the optical transmission line 42 and lower than the strength of the monitor wavelength λsp component in troubled conditions of the optical transmission line 42.

The comparator circuit 64 compares output of the amplifier 62 with the threshold value Vth, and outputs a H signal (alarm ON) when the output of the amplifier 62 is higher than the threshold value Vth, and a L signal (alarm OFF) otherwise. The H output signal of the comparator circuit 64 indicates that any trouble or abnormality has occurred on the side of the optical transmission line 42 including the optical unit 46, and it is processed as an alarm signal indicating it. For example, it is utilized to generate a buzzer, and/or to turn on or flash a red lamp indicating the occurrence of the trouble. The portion including the amplifier 62 and the comparator circuit 64 corresponds to the circuit for judging troubles in the optical transmission system.

Light output from the other end of the optical fiber grating 58 of the optical unit 46 enters into the photodetector 66 of the electronic unit 48. The electronic unit 48 has substantially the same construction as the conventional one. That is, it includes a photodetector 66 and a data demodulating circuit 68 for restoring received data from the output of the photodetector 66 and for reproducing the clock. The data demodulating circuit 68 outputs an alarm #1, similarly to the data demodulating circuit 34, when it cannot reproduce the clock.

Explained below are operations of the embodiment, especially an operation for monitoring the transmission line at the receiving station 44 is explained in detail. Signal light output from the sending station 40 propagates on the optical transmission line 42 and enters into the receiving station 44. Besides the signal light, however, spontaneously emitted light output from the sending station 40 or generated at active devices such as the optical amplifier 12b also inputs to the receiving station 44, after amplified as noise light at the optical amplifier 12b.

At the optical unit 46 of the receiving station 44, the optical amplifier 50 optically amplifies input light from the optical transmission line 42, and the wavelength dispersion compensation fiber 52 compensates accumulated wavelength dispersion of output light, especially signal light, from the optical amplifier 50. The output light of the wavelength dispersion compensation fiber 52 is amplified for the second time by the optical amplifier 54 and enters into the terminal A of the optical circulator 56.

Since the optical circulator 56 outputs the input light of the terminal A from the terminal B, output light of the optical amplifier 54, consequently, applies to the optical fiber grating 58. The optical fiber grating 58, as explained beforehand, is designed to reflect the monitor wavelength λsp different from the wavelength of the signal light and, therefore, the signal light passes through there without getting almost any loss and inputs to the photodetector 66 of the electronic unit 48.

The photodetector 66 generates electronic signal according to the intensity and variation of input light from the optical fiber grating 58, and applies it to the data demodulating circuit 68. The data demodulating circuit 68 demodulates transmission data from the output signal of the photodetector 66 along with reproducing the clock. The data demodulating circuit 68 also outputs an alarm #1, similarly to the data demodulating circuit 34, when it cannot reproduce the clock.

The monitor wavelength λsp component reflected by the optical fiber grating 58 enters into the terminal B of the optical circulator 56, exits from the terminal C, and enters into the photodetector 60. The photodetector 60 outputs an electric signal indicating the intensity of the monitor wavelength component in the input light from the optical transmission line 42. Output of the photodetector 60 is amplified or current-to-voltage-converted by the amplifier 62, and then applied into one input of the comparator circuit 64. The comparator circuit 64 compares the output of the amplifier 62, namely, the level of the monitor wavelength λsp of the input light from the optical transmission line 42 with the threshold value Vth, and issues a H output (high output: alarm ON) when the output of the amplifier 62 exceeds the threshold value Vth or a L output (low output: alarm OFF) otherwise.

Output of the comparator circuit 64 is given as an alarm #2 to administrators. For example, when the output of the comparator circuit 64 is L, an alarm lamp (not shown) may be lit in green to show the normal condition. When the output of the comparator circuit 64 is H, the alarm lamp may be lit or flashed in red to show the occurrence of the trouble. A buzzer may be used alternatively or additionally.

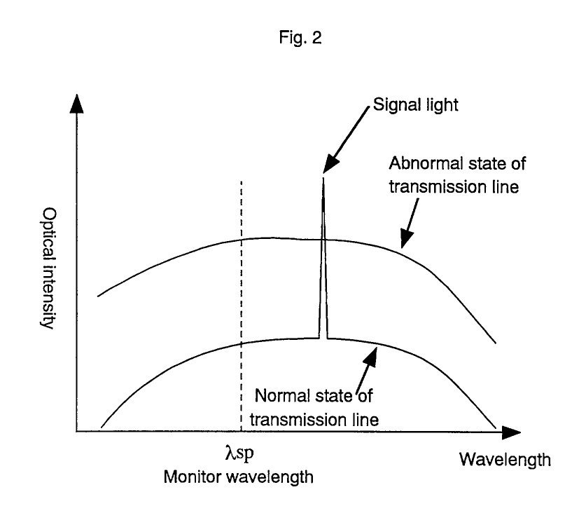

Assume here that the optical transmission line 42 is broken at a portion unknown. Then, no signal light enters into the optical amplifiers 12b, 50, 54 located after the breakage of the line, and it results in amplifying spontaneously emitted light more intensively after the breakage and in increasing its optical intensity. Especially, the amplification gain wavelength characteristics of the optical amplifiers 12b, 50, 54 cause the intensity of the spontaneously emitted light to be increase more prominently on the side of shorter wavelengths than the signal wavelength. FIG. 2 is a spectrally comparative diagram between the normal state and a troubled state of the optical transmission line 42, putting optical intensities on the ordinate and the wavelengths on the abscissa.

As the intensity of spontaneous emission increases, the intensity of the monitor wavelength λsp also increases. Accordingly, the output level of the photodetector 60, namely, the output level of the amplifier 62 increases, and it finally exceeds the threshold value Vth in the comparator circuit 64. When the output level of the amplifier 62 exceeds the threshold value Vth, output of the comparator circuit 64 changes from L (alarm OFF) to H (alarm ON). In case of a breakage in the optical transmission line 42, the data demodulating circuit 68 cannot reproduce the clock, and outputs alarm #1. Only with the alarm #1, like the conventional device, administrators cannot know whether the trouble is in the transmission line 42 or not. In this embodiment, however, also the alarm #2 (output from the comparator circuit 64) is given to administrators to notify that the trouble is in the optical system.

When only the alarm #1 is output without the alarm #2, it is highly possible that the trouble has occurred in the photodetector 66 or the data demodulating circuit 68. Although the same alarm mode is exhibited also when a trouble occurs while the photodetector 60 or the amplifier 62 involves a malfunction. However, this situation seldom occurs since the photodetector 60 and the amplifier 62 may be low-speed circuit elements which are much more reliable and much less liable to malfunction than the photodetector 66 and the data demodulating circuit 68.

In the embodiment shown in FIG. 1, the photodetector 60, amplifier 62 and comparator circuit 64 which are electronic elements or circuits of the optical transmission line monitoring apparatus are located in the optical unit 46. However, they may be located in the electronic unit 48. The optical circulator 56 and optical fiber grating 58 may be located before or after the optical amplifier 50, or before the optical amplifier 54, instead of the position before the optical amplifier 54. When the transmission loss of the signal light by the optical circulator 56 and/or the optical fiber grating 58, the optical circulator 56 and the optical fiber grating 58 are preferably disposed after the optical amplifiers 50, 54.

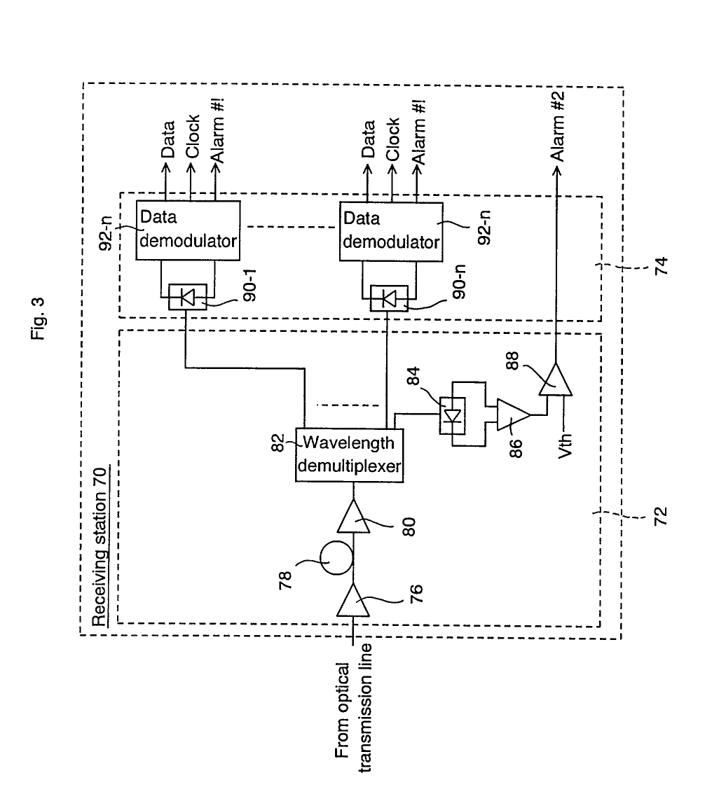

FIG. 3 is a schematic block diagram of a second embodiment of the invention suitable for a wavelength-division multiplexing transmission system. A receiving station 70 includes an optical unit 72 and an electronic unit 74. Similarly to the conventional structure and the embodiment shown in FIG. 1, the optical unit 72 includes an optical amplifier 76 directly connected to the optical transmission line 42, a wavelength dispersion compensation fiber 78 for compensating accumulated wavelength dispersion of the output light from the optical amplifier 76 and an optical amplifier 80 for optically amplifying the output light to compensate the loss of the wavelength dispersion compensation fiber 78.

The optical unit 72 according to this embodiment, however, further includes a wavelength demultiplexing device 82 for demultiplexing the monitor wavelength λsp and at least one wavelength in the wavelength-division multiplexed signal light from the output light of the optical amplifier 80. The wavelength demultiplexing device 82 is an optical device for demultiplexing input light into a plurality of predetermined wavelength components, and may be, for example, an array waveguide grating. Alternatively, the wavelength demultiplexing device 82 may be an optical device made by serially connecting some optical filter structures each including the optical circulator 56 and the optical fiber grating 58 shown in FIG. 1 to extract an individually assigned wavelength. The monitor wavelength λsp is preferably shorter than the wavelength of the signal light by more of 0.8 nm, which is the interval of wavelengths in the wavelength-division multiplexing transmission system.

Output having the monitor wavelength λsp in different wavelength outputs from the wavelength demultiplexing device 82 is applied to the photodetector 84. Output of the photodetector 84 is connected to the input of the amplifier 86, and output of the amplifier 86 is connected to one input of the comparator circuit 88. The photodetector 84 and the amplifier 86 may be low-speed circuit elements in which output of the amplifier 86 exhibits the d.c. level of the monitor wavelength λsp component entering into the photodetector 84. The threshold value Vth for the alarm output enters to the other input of the comparator circuit 88. The comparator circuit 88 compares the output of the amplifier 86 with the threshold value Vth, and issues a H signal (alarm ON) when the output of the amplifier 86 exceeds the threshold value Vth, and a L signal (alarm OFF) otherwise. Constructions and operations of the photodetector 84, amplifier 86 and comparator circuit 88 are identical to those of the photodetector 60, amplifier 62 and comparator circuit 64 in FIG. 1. The portion consisting of the amplifier 86 and the comparator circuit 88 corresponds to the circuit for judging troubles in the optical transmission system.

The electronic unit 74 includes photodetectors 90-1 through 90-n and data demodulating circuits 92-1 through 92-n for receiving and processing respective wavelength components demultiplexed by the wavelength demultiplexing device 82 of the optical unit 72. Excepting that different wavelength components enter into different photodetectors 90-1 to 90-n, the photodetectors 90-1 to 90-n and the data demodulating circuits 92-1 to 92-n have the same constructions and functions as those of the photodetector 66 and the data demodulating circuit 68 shown in FIG. 1. That is, the data demodulating circuits 92-1 through 92-n demodulate received data from outputs of associated photodetectors 90-1 to 90-n, and reproduce the clock or output alarm #1 when they cannot reproduce the clock.

Next explained are operations of the unique portion of the embodiment shown in FIG. 3. Light from the optical transmission line enters into the wavelength demultiplexing device 82 through the optical amplifier 76, wavelength dispersion compensation fiber 78 and optical amplifier 80. The wavelength demultiplexing device 82 demultiplexes output light from the optical amplifier 80 into a plurality of different wavelength components, and delivers the monitor wavelength λsp component to the photo detector 84 and the other signal wavelength components to the photo detectors 90-1 through 90-n.

The photo detector 84 converts the intensity of the monitor wavelength λsp component into an electric signal, and its output is current-to-voltage-converted by the amplifier 86 and applied to one input of the comparator circuit 88. The photodetector 84 and the amplifier 86 may be low-speed circuit elements such that the output of the amplifier 86 exhibits the d.c. level of the monitor wavelength λsp component entering into the photodetector 84. The comparator circuit 88 compares the output of the amplifier 86, namely, the d.c. level of the monitor wavelength λsp component in the input light from the optical transmission line with the threshold value Vth, and issues a H signal (alarm ON) when the output of the amplifier 86 exceeds the threshold value Vth or a L signal (alarm OFF) otherwise.

Output of the comparator circuit 88 is given as an alarm #2 to administrators. For example, when the output of the comparator circuit 88 is L, an alarm lamp (not shown) may be lit in green indicating the normal condition. When the output of the comparator circuit 88 is H, the alarm lamp may be lit or flashed in red indicating the existence of a trouble. A buzzer may be used alternatively or additionally.

Different signal wavelength components demultiplexed by the wavelength demultiplexed device 82 are applied individually to the photodetectors 90-1 through 90-n of the electronic unit 74, and the photodetectors 90-1 through 90-n output electric signals responsive to the input light intensities to the data demodulating circuit 92-1 through 92-n. The data demodulating circuits 92-1 through 92-n demodulate transmitted data from the output signals of the photodetectors 90-1 through 90-n, and reproduce the clock. When the data demodulating circuits 92-1 through 92-n cannot reproduce the clock, they output alarm #1 similarly to the data demodulating circuits 34 and 68.

If any trouble occurs in the optical transmission line, then the alarm #2 output from the comparator 88 and all alarms #1 output from the respective data demodulating circuits 92-1 through 92-n are ON. If a trouble occurs in any of the photodetectors 90-1 through 90-n or data demodulating circuits 92-1 through 92-1 of the electronic unit 74, then the alarm #1 output from corresponding one of the data demodulating circuits 92-1 through 92-n turns ON, but the alarm #2 output from the comparator 88 remains OFF. Therefore, referring to the ON-OFF aspect of these alarms, it can be quickly identified whether a trouble is only in the optical system or not.

In the embodiment shown in FIG. 3, electronic devices or circuits of the optical transmission line monitoring apparatus, namely, photo detector 84, amplifier 86 and comparator 88, are located in the optical unit 72; however, they may be located in the electronic units 48 or 74.

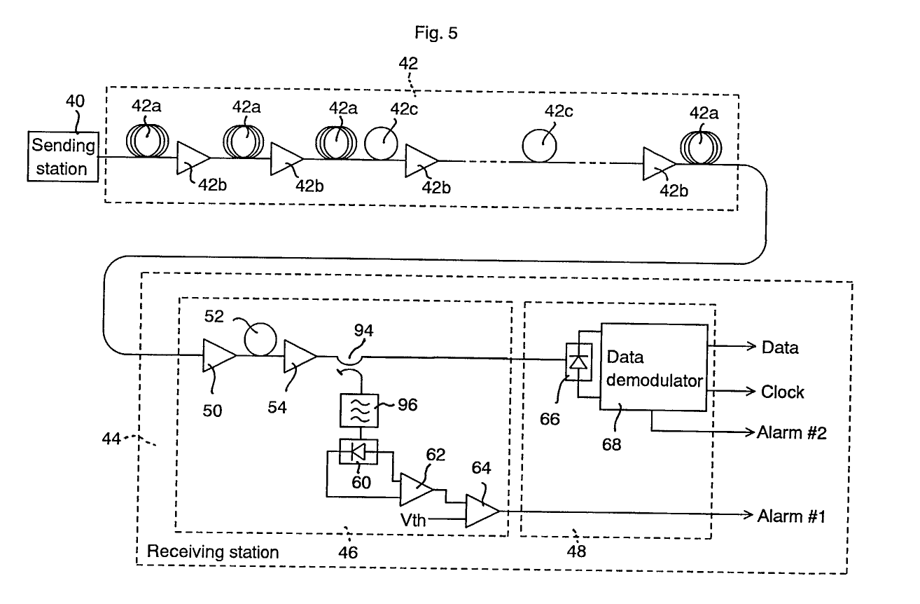

Instead of using the optical circulator 56 as means for extracting the spontaneously emitted light component or noise light having the monitor wavelength λsp, an optical filter may be used to extract the monitor wavelength λsp component from a part of the output of the optical amplifier 54. A schematic block diagram of the modified embodiment is shown in FIG. 5, using common numerals on the same elements as those of FIG. 1. Numeral 94 denotes an optical coupler for dividing output of the optical amplifier 54 into two parts, one of which is applied to the photodetector 66 in the electronic unit 48 and the other of which is applied to an optical filter 96 for extracting the monitor wavelength λsp. Output of the optical filter 96 is applied to the photodetector 60.

As described above, the invention makes it possible to quickly identify a trouble in an optical system and to quickly undertake a remedial work to restore the system.

1. An optical transmission line monitoring apparatus comprising:
monitor wavelength extracting means for extracting a predetermined monitor wavelength from input light; and
judging means for judging whether any trouble is present in the optical transmission system by comparing the intensity of output light from said monitor wavelength extracting means with a predetermined threshold value.

2. The optical transmission line monitoring apparatus according to claim 1 wherein said monitor wavelength extracting means includes an optical grating member for selectively reflecting said monitor wavelength, and an optical circulator having three terminals for transferring said input light to said optical grating member and for outputting the light reflected by the optical grating member from a terminal other than the input terminal of said input light.

3. The optical transmission line monitoring apparatus according to claim 1 wherein said monitor wavelength extracting means comprises an optical filter.

4. The optical transmission line monitoring apparatus according to claim 1 wherein said monitor wavelength extracting means comprises a wavelength demultiplexing means for demultiplexing said input light into a plurality of different wavelength components including said monitor wavelength component.

5. The optical transmission line monitoring apparatus according to claim 4 wherein said monitor wavelength extracting means comprises an arrayed waveguide grating.

6. The optical transmission line monitor apparatus according to claim 1 wherein said judging means includes opto-electric converting means for converting the intensity of output light from said monitor wavelength extracting means into an electric signal, and comparing means for comparing output of said opto-electric converting means with said threshold value.

7. The optical transmission line monitoring apparatus according to claim 1 wherein said monitor wavelength is shorter than the wavelength of the signal light.

8. A receiving station comprising:
a wavelength demultiplexing means for demultiplexing a predetermined monitor wavelength and at least one signal wavelength from input light from an optical transmission line;
a reception-processing means for reception-processing said at least signal wavelength component demultiplexed by said wavelength demultiplexing means; and
judging means for judging from the optical intensity of said monitor wavelength component demultiplexed by said wavelength demultiplexing means whether a trouble is present or not in the optical transmission system containing said optical transmission line.

9. The receiving station according to claim 10 further comprising first optical amplifying means for optically amplifying said input light from said optical transmission line; accumulated wavelength dispersion compensating means for compensating accumulated wavelength dispersion of output light from said first optically amplifying means; and second optically amplifying means for optically amplifying output light from said accumulated wavelength dispersion compensating means.
